(19) United States
(12) Patent Application Publication
(10) Pub. No.: US 2014/0322694 A1
(43) Pub. Date: Oct. 30, 2014

(54) METHOD AND SYSTEM FOR UPDATING LEARNING OBJECT ATTRIBUTES

(71) Applicant: APOLLO GROUP, INC., PHOENIX, AZ (US)

(72) Inventors: Venkata Kolla, Union City, CA (US); Pavan Aripirala Venkata, Fremont, CA (US); Sumit Kejriwal, Bangalore (IN); Raghuveer Murthy, Bangalore (IN); Narender Vattikonda, San Jose, CA (US)

(73) Assignee: APOLLO GROUP, INC., PHOENIX, AZ (US)

(21) Appl. No.: 13/874,139

(22) Filed: Apr. 30, 2013

(51) Int. Cl. G09B 5/08

(52) U.S. Cl. CPC G09B 5/08
USPC 434/362

(57) ABSTRACT

A method and system are provided for enabling one or more attribute values of a learning object to be derived and updated based upon learner actions taken by a plurality of learners on that learning object or on one or more related learning objects. To keep the attribute values current, the attribute values may be updated as new/additional information is received. Once the one or more attribute values are derived and updated, they can be used to make intelligent and effective decisions on whether and when to use the learning object to educate a learner.

### FIELD OF THE INVENTION

The present invention relates generally to education and more particularly to a method and system for updating the attributes of learning objects that are used for educational purposes.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In recent years, the Internet has proliferated greatly to the point where a majority of people have access, in some form, to the Internet. With its expansive reach, the Internet provides an excellent medium for facilitating online education. Through the Internet, an online educational institution can provide courses on a variety of topics, and learners can take advantage of these courses without having to leave their homes or offices to go to a meeting site.

An online course may be a live course that is taught by a faculty member and streamed to various learners, or it may be an independent study course that can be accessed at any time by a learner. In either case, an online course may comprise at least two main components: a content component; and an assessment component. The content component is the component that includes the materials that the learner has to review/study in order to learn the concepts and topics taught by the course, and the assessment component is the component that determines how well the learner has learned the concepts and topics.

To maximize benefit to the learner, it would be desirable to select the best possible content and assessment components for the learner. For example, it would be desirable to select the content materials that are most effective for teaching the concepts and topics of the course, and to select the best and most appropriate test questions to ask the learner. Before such selections can be made, however, it may be necessary to derive values for certain attributes of the various components, which would be used in making the selections. To derive these values, it may be necessary to gather and process data from many different learners. The more effective the data gathering and processing mechanism is, the better the values that can be derived, and the better the selections that can be made. As a result, an effective information gathering and processing mechanism is needed.

### BRIEF DESCRIPTION OF THE DRAWINGS

FIG. 1 is a block diagram of a system in which one embodiment of the present invention may be implemented.

FIG. 2 is high level flow diagram of a methodology that may be used to derive an updated value for an attribute associated with a learning object, in accordance with one embodiment of the present invention.

FIG. 3 is a block diagram of a computer system that may be used to implement at least a portion of the present invention.

### DETAILED DESCRIPTION OF EMBODIMENT(S)

### Overview

In accordance with one embodiment of the present invention, a method and system are provided for enabling one or more attribute values of a learning object to be derived and updated based upon learner actions taken by a plurality of learners on that learning object or on one or more related learning objects. To keep the attribute values current, the attribute values may be updated as new/additional information is received. Once the one or more attribute values are derived and updated, they can be used to make intelligent and effective decisions on whether and when to use the learning object to educate a learner.

As used herein, the term learning object refers broadly to any object, item, construct, container, data structure, etc. that is used for teaching, learning, or educational purposes. A learning object may be of several different types, including but not limited to content and assessment types. A content learning object is a learning object that includes, references, or contains educational content that teaches one or more concepts or topics. The educational content may, for example, take the form of a book, a paper or other type of reading material, a video, audio, or audio/visual recording, a tutorial, etc. An assessment learning object is a learning object that is used to test, assess, or determine how well a learner has learned a concept or topic. Examples of an assessment learning object include but are not limited to a test question, a quiz or test with multiple test questions, an exam, a collection of multiple quizzes, tests, or exams, etc.

A learning object may have any desired level of granularity. For example, a content learning object may be a fine-grained object that includes, references, or contains just a single set of educational content, or it may be a more encompassing object that includes, references, or contains several sets of educational content that make up a portion of a course or all of a course, or it may be a very encompassing object that includes, references, or contains all of the sets of educational content that make up all of the courses in a semester, in a year, or in an entire degree plan. Similarly, an assessment learning object may be a fine-grained object that includes, references, or contains just a single test question, or it may be a more encompassing object that includes, references, or contains multiple test questions that make up a test or quiz, or it may be an even more encompassing object that includes, references, or contains a collection of tests, quizzes, or exams, each of which would include multiple test questions. For purposes of the present invention, a learning object may have any desired level of granularity.

Each learning object may have one or more attributes, and each attribute may have one or more values. The attributes may be of different types, including but not limited to static and dynamic. A static attribute is one that is set and most likely does not change. For example, a content or assessment learning object may have a “topic” attribute that indicates the topic with which it is associated. This attribute is not likely to change; thus, it is static. A dynamic attribute is one that may be updated as new or additional information is received. For example, an assessment learning object that contains a single test question may have a “difficulty level” attribute. As different learners submit responses to the test question, the value of the “difficulty level” attribute may be updated. For example, as more learners answer the question incorrectly, the value of the “difficulty level” attribute may be increased to indicate that it is a more difficult question. Because the “difficulty level” attribute is updated as additional information is received, it is a dynamic attribute. In one embodiment of the present invention, a method and system are provided for deriving updated values for dynamic attributes of learning objects based upon learner actions taken by a plurality of learners on those learning objects or on other learning objects that are related to those learning objects. Once these dynamic attribute values of learning objects are derived and updated, they can be used to make intelligent and effective decisions on whether and when to use the learning objects to educate learners.

### Sample System

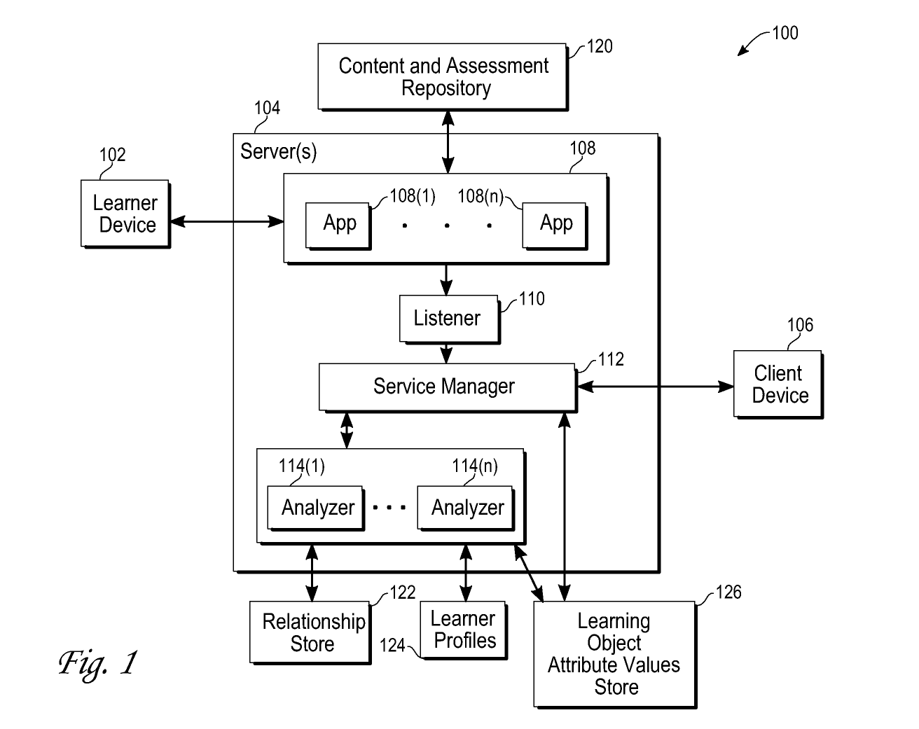

With reference to FIG. 1, there is shown a block diagram of a system 100 in which one embodiment of the present invention may be implemented. As shown, the system 100 comprises a learner device 102, one or more servers 104, and a client device 106 (for the sake of simplicity, only one learner device 102 and one client device 106 are shown, but it should be noted that, for purposes of the present invention, any desired number of learner and client devices may interact with the server(s) 104). The learner device 102 and client device 106 may take on any of various forms, including but not limited to desktop computers, laptop computers, tablet computers, smartphones, mobile devices, etc. In one embodiment, the learner device 102 is used by a learner to interact with one or more applications 108 on the server(s) 104 to enable the learner to take advantage of educational resources provided by the server(s) 104, and the client device 106 is used by a client (e.g. a professor, faculty member, administrator, or other user of the system 100) to interact with a service manager 112 of the server(s) 104 to enable the client to access one or more services provided by the server(s) 104. The learner and client devices 102, 106 may execute a web browser or one or more dedicated applications in order to interact with the server(s) 104. The learner device 102 and client device 106 may communicate with the server(s) 104 via the Internet, a local area network (LAN), a wide area network (WAN), or any other type of network.

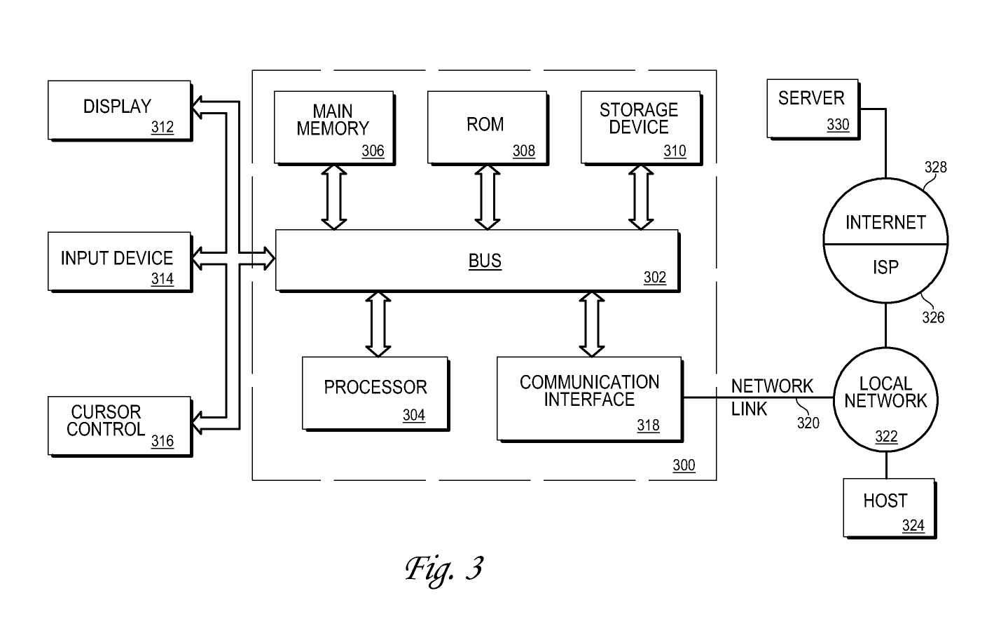

The server(s) 104 may be implemented as one or more computer systems. If the server(s) 104 are implemented as multiple computer systems, then the multiple computer systems may be implemented as a cluster, wherein the various computer systems communicate and cooperate with each other. Each of the computer systems may, for example, take the form shown in FIG. 3 (which will be discussed in a later section). If the server(s) 104 is implemented using a single computer system, then all of the components shown in FIG. 1 as being within the server(s) 104 may execute on that single computer system. If the server(s) 104 are implemented using a plurality of computer systems, then the components shown in FIG. 1 as being within the server(s) 104 may be executed in any desired combination on the various computer systems. For example, the applications 108, listener 110, service manager 112, and analyzers 114 may each be executed on a separate computer system, or some may be executed on one computer system while others are executed on other computer systems. For purposes of the present invention, components 108, 110, 112, and 114 may be executed on any computer system in any desired combination. Other components not shown in FIG. 1 may also execute on the one or more computer systems. For the sake of simplicity, it will be assumed hereinafter that the components 108, 110, 112, and 114 execute on a single computer system (i.e. a single server 104); however, it should be noted that this is not required.

In one embodiment, the applications 108 are the components that enable a learner to interact with the server 104 to take advantage of the educational resources provided by the server 104. There may be a plurality of applications 108(1)-108(n), and each application 108 may pertain or be specific to a course or multiple courses. In interacting with a learner device 102, an application 108 may perform a variety of functions. For example, an application 108 may provide one or more content learning objects (e.g. reading materials, videos, tutorials, etc.) to the learner device 102 to teach the learner one or more concepts or topics pertaining to a course. The application 108 may also render one or more assessment learning objects (e.g. test questions, quizzes, etc.) to the learning device 102 to test how well the learner has learned the one or more concepts or topics in a course. In performing these functions, the application 108 may access a content and assessment repository 120. In one embodiment, this repository 120 stores the content learning objects and the assessment learning objects that are associated with various courses.

Furthermore, the application 108 may receive responses from the learner to the one or more assessment learning objects (these responses may be viewed as learner actions taken by the learner on the assessment learning objects). The application 108 may perform various functions on these responses (learner actions). For example, if the learner submits a response to a single test question, the application 108 may determine whether the learner answered the question correctly, how long the learner took to answer the question (this may be the time period between the rendering of the test question and the receipt of the learner response), whether the learner provided an answer to the question at all, etc. These and other aspects of the learner response may be determined by the application 108. In one embodiment, the application 108 stores the various aspects of the learner response into repository 120 for later use. The application 108 may also store into repository 120 various aspects of other types of learner actions taken on various learning objects. For purposes of the present invention, an application 108 may be programmed or configured to determine any aspects of any type of learner action performed on any learning object, and may store information pertaining to these aspects into the repository 120. As will be discussed in a later section, this information pertaining to the various aspects of learner actions taken on learning objects may be used to derive updated values for one or more dynamic attributes of one or more learning objects.

In addition to performing the functions mentioned above, an application 108 may also provide to a listener 110 information pertaining to learner actions taken by the learner on learning objects. These learner actions may, for example, be learner actions taken on assessment learning objects (such as responses to individual test questions, responses to tests having multiple test questions, etc.), or learner actions taken on other types of learning objects. As will be elaborated upon in a later section, other components in the sever 104 may be interested in such learner actions, and may use information pertaining to these learner actions to, for example, update one or more dynamic attributes of one or more learning objects, make one or more recommendations, etc. In one embodiment, when an application 108 detects a learner action taken by a learner on a learning object, the application 108 may send a learner action message to the listener 110. The learner action message may include the following information: (a) the type of learner action (e.g. submission of a response to a single test question, submission of a response to a test with multiple test questions, etc.); (b) the identifier of the learning object on which the learner action was taken; (c) a session identifier; and (d) some context information, which may include, for example, a learner identifier for the learner who took the action and a course identifier for a course with which the learning object is associated. The learner action message may include other/additional information about the learner action, if so desired.

Upon receiving the learner action message from the application 108, the listener 110 may perform one or more filtering operations to determine whether the message should be forwarded to the service manager 112 (e.g. it may be desirable to forward only certain types of learner actions to the service manager 112). If the learner action message is forwarded to the service manager 112, then in one embodiment, based at least in part upon the information in the learner action message and upon an analyzer mapping (elaborated upon below), the service manager 112 selects one or more analyzers 114, and forwards the information in the learner action message to the selected analyzers 114 for further processing. In effect, the service manager 112 invokes the selected analyzers 114. In response to the invocation, the selected analyzers 114 may perform various functions, including, for example, deriving one or more updated values for one or more dynamic attributes of one or more learning objects, making one or more recommendations, etc. For purposes of the present invention, the selected analyzers 114 may perform any desired function(s).

The server 104 may comprise a plurality of analyzers 114(1)-114(n). In one embodiment, the analyzers 114 may be “plugged in” to the server 104. By this, it is meant that an analyzer 114 may be incorporated into the server 104 without shutting down and restarting the server 104. To plug a new analyzer 114 in to the server 104, a system administrator may add the code or instructions for the new analyzer 114 to the server 104, and register the new analyzer 114 with the service manager 112. During registration, the system administrator may specify one or more criteria to be associated with the new analyzer 114. These criteria in effect tell the service manager 112 when the new analyzer 114 is to be invoked. For example, the criteria may indicate that the new analyzer 114 is to be invoked only when a certain type of learner action is taken on a specific learning object. The criteria may be as detailed and as fine grained or coarse grained as desired. This ability to specify invocation criteria gives a developer of an analyzer 114 significant control over when and how the analyzer 114 is used. These criteria are stored in the analyzer mapping mentioned above, and are used by the service manager 112 to determine when information pertaining to a learner action should be forwarded to the new analyzer 114 for processing. In one embodiment, to enable the “plug in” ability, the analyzers 114 are implemented as components under the open services gateway initiative (OSGI) framework. It should be noted, though, that this is just one possible implementation. Other implementations are also possible and are within the scope of the present invention.

With the ability to plug in analyzers 114, and the ability to specify the criteria that govern when the analyzers 114 are invoked, a user of system 100 can exercise great control over what processing is done (e.g. how dynamic attribute values are updated, how recommendations are made, etc.), and on which learner actions and which learning objects the processing is performed. With such control, different users can provide different methodologies for processing learner actions taken on their learning objects. For example, a first professor of a first course may provide a first set of analyzers 114 for processing learner actions that are taken on the learning objects that are part of the first course. This set of analyzers 114 may process the learner actions and the learning objects in any way desired by the first professor. For example, the first set of analyzers 114 may update dynamic attributes of the learning objects using any algorithm or methodology desired by the first professor, and may make recommendations in any manner desired by the first professor. Likewise, a second professor of a second course may provide a second set of analyzers 114 for processing the learner actions that are taken on the learning objects that are part of the second course. This set of analyzers 114 may process the learner actions and the learning objects in any way desired by the second professor. For example, the second set of analyzers 114 may update dynamic attributes of the learning objects using any algorithm or methodology desired by the second professor, and may make recommendations in any manner desired by the second professor. Thus, with system 100, there is great flexibility and versatility in the manner in which dynamic attribute values can be updated, and in the manner in which recommendations can be made.

When an analyzer 114 receives a learner action message from the service manager 112 for further processing, the analyzer 114 may not have all of the information that it needs to perform the desired processing. In such a case, the analyzer 114 may query one or more of the applications 108 for additional information. As noted previously, an application 108 stores in the repository 120 various aspects of learner actions taken on various leaning objects. Also, as noted previously, the learner action message may include various sets of information, including a session identifier and a learning object identifier. Using this and perhaps other sets of information, the analyzer 114 may query an application 108 to obtain more information about the learner action referenced in the learner action message and about other learner actions as well.

For example, suppose that the learner action in the learner action message is a submission of a response to an assessment learning object that contains a single test question. Using the learning object identifier and the session identifier in the learner action message, the analyzer 114 may query an application 108 to obtain information about the specific aspects of the learner's response (e.g. whether the learner answered the question correctly, how long the learner took to answer the question, whether the learner provided an answer to the question at all, etc.). The analyzer 114 may also request information pertaining to other learner actions (e.g. how many other learners have submitted responses to this test question, how many other learners answered the question correctly, how long did the other learners take to answer the question, how many other learners did not provide an answer to the question at all, etc.). Using the information received from the application 108, the analyzer 114 can perform the desired processing, which may include deriving an updated value for one or more dynamic attributes of one or more learning objects, making one or more recommendations, etc. As an example, the analyzer 114 may use the information to derive an updated value for a “difficulty level” attribute of the assessment learning object.

In performing its processing, an analyzer 114 may make use of other information as well, such as the information stored in a relationship store 122 and the information contained in a set of learner profiles 124. In one embodiment, the relationship store 122 contains information that indicates the relationships between learning objects. This information may be set forth in an ontology using, for example, a web ontology language. Given the ontology information, it is possible to determine how learning objects are related to each other. For example, the relationship store 122 may contain information indicating that a content learning object is associated with a particular topic and a particular course. The relationship store 122 may also contain information indicating that an assessment learning object is likewise associated with the particular topic and the particular course. Given this information, it can be determined that the content learning object and the assessment learning object are related to each other. This is a simple example of how the ontology information may be used to derive relationships between learning objects. Much more complex relationships can be derived. These relationships may be used by an analyzer 114 to facilitate various types of processing (e.g. recommending other learning objects based upon a learner action taken on a first learning object, updating the dynamic attribute value of a learning object based upon learner actions taken on a related learning object, etc.). An example of how the information in the relationship store 122 may be used will be provided in a later section.

The learner profiles 124 contain information about the various learners using the system 100. In one embodiment, each learner profile pertains to a specific learner, and contains all of the information relevant to that learner. For example, a learner profile may indicate which courses the learner has taken and is taking, what grades the learner received in those courses, which specific concepts or topics the learner has mastered, the skill level of the learner in various concepts or topics, etc. This and other information may be maintained in a learner's profile. The information in a learner's profile may be used advantageously by an analyzer 114 in, for example, updating dynamic attribute values and making recommendations. For example, in updating the “difficulty level” of an assessment learning object that contains a single test question, an analyzer 114 may take into account the skill level of the learner. If the learner answered the test question incorrectly, and if the learner is highly skilled in the topic covered by the test question, then the analyzer 114 may increase the “difficulty level” of the assessment learning object more than if the test question had been answered incorrectly by a learner who is not highly skill in the topic. As a further example, in recommending a next assessment learning object (e.g. a next test question) to render to a learner, the analyzer 114 may recommend a higher difficulty level assessment learning object for a learner who is highly skilled in a topic than for a learner who is not highly skilled in the topic. In these and other ways, an analyzer 114 may take advantage of information in a learner's profile in performing its processing.

In one embodiment, after the analyzers 114 derive updated values for dynamic attributes of learning objects, they pass the updated values to the service manager 112, which in turn stores the updated values into a learning object attribute values store 126. Alternatively, the analyzers 114 may store the updated values into the attribute values store 126 themselves. Once stored, the updated values for the dynamic attributes of the learning objects may be used to make intelligent and effective decisions on whether and when to use the learning objects to educate learners. The information in the attribute values store 126 may be used by the analyzers 114 to make recommendations, and/or may be used by the service manager 112 to service recommendation requests from the client 106. The information in the attribute values store 126 may also be used for other purposes unrelated to recommendations (e.g. to select test questions that are to be included in an adaptive test in which test questions are selected based upon the learner's responses to previous questions).

### High Level Operation

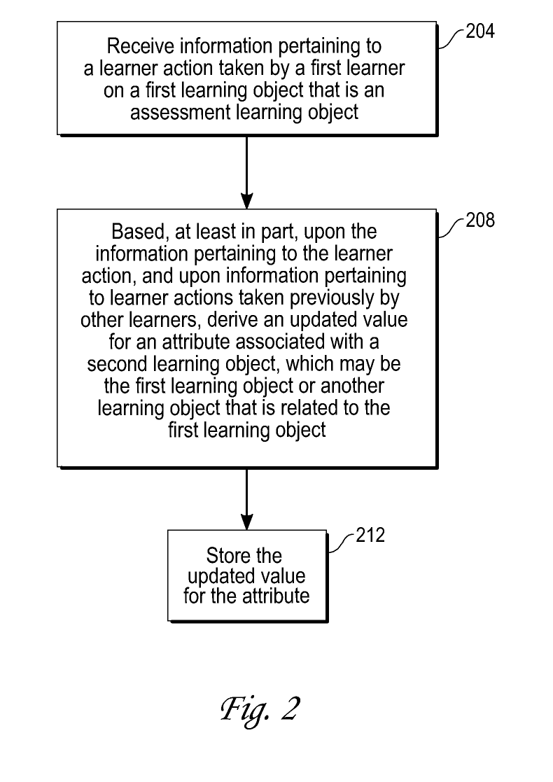

With reference to FIG. 2, there is shown a flow diagram that provides a high level overview of a methodology implemented by system 100 to derive an updated value for an attribute associated with a learning object, in accordance with one embodiment of the present invention.

According to the methodology, information is received (block 204) pertaining to one or more aspects of a learner action taken by a learner on a first learning object, wherein the first learning object is an assessment learning object. Based, at least in part, upon the information pertaining to the one or more aspects of the learner action and upon information pertaining to one or more aspects of learner actions taken previously by other learners, an updated value for an attribute is derived (block 208). The attribute for which the updated value is derived may be associated with the first learning object or a second learning object that is related to the first learning object. After the updated value for the attribute is derived, it is stored (block 212) for later use. Using the updated value for the attribute, intelligent and effective decisions can be made on whether and when to use the learning object (with which the attribute is associated) to educate a learner.

The flow diagram shown in FIG. 2 is quite high level. To provide some context to facilitate a complete understanding of the present invention, several possible use cases for the system 100 will be described below. It should be noted, however, that the following use cases are provided for illustrative purposes only. The present invention should not be limited to these use cases. In fact, many other use cases are possible, and are within the scope of the present invention.

### Sample Use Cases

### Use Case #1

In this use case, an updated value is derived for an attribute of a learning object based upon learner actions taken by a plurality of learners on that learning object.

Suppose that a learner, with learner identifier L1, uses the learner device 102 to interact with application 108(1) to participate in a course having course identifier C1. At some point in the interaction, application 108(1) renders an assessment learning object having object identifier O1 to the learner to test the learner's knowledge of a topic T1 taught by the course C1. In this use case, the assessment learning object is a single-question type of object (e.g. the assessment learning object contains a single test question). Also, the assessment learning object has two static attributes, “course” and “topic”, and three dynamic attributes, “difficulty level”, “discrimination level”, and “guess level”. The “course” and “topic” static attributes have values of C1 and T1, respectively. The dynamic attributes have values that are derived. In this use case, the “difficulty level” attribute indicates how difficult the test question is, the “discrimination level” attribute indicates how effectively the test question differentiates between learners of different skill level in the topic T1, and the “guess level” attribute indicates how easy it is to guess the correct answer for the test question.

When the learner submits a response to the test question, the application 108(1) interprets the response as a learner action taken by the learner on the assessment learning object O1. The application 108(1) performs several operations in response. These operations include determining the various aspects of the learner action. In this use case, the application 108(1) notes the answer (if any) provided by the learner, determines whether the answer is correct or incorrect, determines how much time the learner took to answer the question (this may be the time period between the rendering of the test question and the receipt of the learner response), and determines whether the learner provided an answer at all to the question. The application 108(1) saves these aspects of the learner action, along with some identifying information (e.g. a session identifier, the object identifier O1, the learner identifier L1, etc.), in the repository 120 for potential later use. The application 108(1) also sends a learner action message to the listener 110 to notify the listener 110 of the learner action. This message may include the following information: (a) the learner action type (in this use case, the action type would be a response to a single test question); (b) the assessment learning object identifier O1; (c) the session identifier; and (d) context information that includes the learner identifier L1 and the course identifier C1.

Upon receiving the learner action message, the listener 110 forwards the message to the service manager 112. In turn, using the information in the learner action message, and the analyzer mapping discussed previously, the service manager 112 selects one or more of the analyzers 114 to which to forward the learner action message for further processing. In this use case, it will be assumed that the learner action message is forwarded to analyzer 114(1). It will also be assumed that analyzer 114(1) performs processing to derive updated values for the three dynamic attributes (“difficulty level”, “discrimination level”, and “guess level”) of the assessment learning object O1.

To do so, the analyzer 114(1) needs more information. Thus, using information from the learner action message (e.g. the object identifier O1 and the session identifier), the analyzer 114(1) queries the application 108(1) for information pertaining to the aspects of the learner action referenced in the message. The analyzer 114(1) also queries the application 108(1) for information pertaining to aspects of learner actions taken previously by other learners on the assessment learning object O1. As a result of this/these query/queries, the analyzer 114(1) receives from the application 108(1) the aspects of the learner action, which may include the answer (if any) provided by the learner L1 to the test question, an indication of whether the answer is correct, an indication of how much time the learner L1 took to answer the question, and an indication of whether the learner L1 provided an answer at all to the questions. The analyzer 114(1) also receives information pertaining to other learner actions taken previously by other learners on the assessment learning object. This information pertaining to other learner actions may be summary information (e.g. an indication of how many other learners submitted responses to the test question and how many answered the question correctly, an average time spent by the other learners on the test question, what percentage of learners did not submit an answer at all to the question, etc.), or it may be detailed information that includes all of the details of the previous learner actions (which may include, for example, information on which learner performed each action, what each answer (if any) was, how long each learner took to answer the question, etc.). Using the information received from the application 108(1), the analyzer 114(1) derives an updated value for each of the dynamic attributes of the assessment learning object O1.

For example, to derive an updated value for the “difficulty level” attribute, the analyzer 114(1) may compute a percentage of learners (including learner L1) who answered the question incorrectly, and multiply that percentage by a constant. To refine the value for the attribute, the analyzer 114(1) may take into account the knowledge level of the learners who answered the question (this information is available in the learner profiles 124). For example, if learner L1 answered the question incorrectly, and if learner L1 is highly skilled in topic T1, then learner L1's incorrect answer may be given more weight than the incorrect answers of lesser skilled learners. Hence, the analyzer 114(1) may increase the value of the “difficulty level” attribute more for learner L1's incorrect answer than for an incorrect answer by a lesser skilled learner. The analyzer 114(1) may weight the incorrect answers of other learners in a similar manner. To further refine the value of the attribute, the analyzer 114(1) may take into account the amount of time taken by the learners to answer the question. For example, if the learners, on average, took more time to answer the question than a certain time threshold, then the attribute value may be increased accordingly. In this and other possible manners, the analyzer 114(1) can derive an updated value for the “difficulty level” attribute.

To derive an updated value for the “discrimination level” attribute, the analyzer 114(1) may analyze the manner in which correct and incorrect answers map across learners of different skill level. For example, if the mapping indicates that a large percentage of highly skilled learners (with regard to topic T1) answered the question correctly while a large percentage of lesser skilled learners answered the question incorrectly, then it may be concluded that the question is relatively effective in discriminating among learners of different skill level; hence, a higher value may be assigned to the attribute. Conversely, if the mapping indicates that incorrect and correct answers are distributed relatively evenly across learners of different skill level, then it may be concluded that the question is relatively ineffective in discriminating among learners of different skill level; hence, a lower value may be assigned to the attribute. In this and other possible manners, the analyzer 114(1) can derive an updated value for the “discrimination level” attribute.

To derive an updated value for the “guess level” attribute, the analyzer 114(1) may take into account the number of times or the percentage of times a learner did not even provide an answer to the test question. If this is high, then it may indicate that the answer to the question is not easy to guess; hence, a low value may be assigned to this attribute. Also, the analyzer 114(1) may look at the spread of the answers provided by the learners. For example, if the test question is a multiple choice question with choices a though e, and if there is a high concentration of answers at choices d and e, then it may indicate that choices a through c can be easily eliminated. In such a case, the answer to the test question may be relatively easy to guess given that only two choices are viable; hence, a relatively high value may be assigned to the “guess level” attribute. On the other hand, if the answers are evenly distributed across the different choices, then it may indicate that none of the choices can be easily eliminated. In such a case, the answer to the test question is relatively difficult to guess; hence, a relatively low value may be assigned to this attribute. In this and other possible manners, the analyzer 114(1) can derive an updated value for the “guess level” attribute.

After deriving the updated values for the dynamic attributes, the analyzer 114(1) may forward the updated values to the service manager 112, which in turn stores the updated values into the attribute values store 126. Alternatively, the analyzer 114(1) may store the updated values into the attribute values store 126 itself. Once updated and stored, the attribute values may be used to make intelligent and effective decisions on whether and when to use the assessment learning object O1 to educate a learner. For example, suppose a client (e.g. a professor), using client device 106, submits a recommendation request to the service manager 112 for recommendations on test questions that can be used to test a learner's knowledge of topic T1. Suppose further that the client wants test questions that have certain “difficulty level”, “discrimination level”, and “guess level” values. Using the information in the attribute values store 126, the service manager 112 can recommend test questions (e.g. assessment learning objects) that satisfy the client's criteria. Based upon the updated attribute values, the service manager 112 can intelligently and effectively decide whether to recommend assessment learning object O1 for this purpose.

For maximum effectiveness, it may be desirable to keep the dynamic attribute values of learning objects as current as possible. To do so, the dynamic attributes may be updated each time a relevant learner action is detected. In the current use case, the analyzer 114(1) updates the values of the “difficulty level”, “discrimination level”, and “guess level” attributes each time a learner action is performed on the assessment learning object O1. As an alternative, the analyzer 114(1) may update the values of these attributes at certain intervals (e.g. every twentieth learner action performed on the assessment learning object, at certain time intervals, etc.). As a further alternative, the analyzer 114(1) may update the values of the attributes as needed (e.g. when the analyzer 114(1) or another component needs to use the values of the attributes to, for example, make a decision, make a recommendation, etc.). For purposes of the present invention, these and other approaches may be used for updating the attribute values.

In addition to deriving updated values for the dynamic attributes of assessment learning object O1, the analyzer 114(1) may also perform additional functions. For example, the application 108(1) may be serving an adaptive quiz to the learner L1, wherein the next test question that is rendered to the learner depends on the learner's response to the previous test question. In such a case, the application 108(1) may be waiting for a recommendation from the analyzer 114(1) as to which test question to render next to the learner. Thus, one of the functions of the analyzer 114(1) may be to make a next question recommendation. In making such a recommendation, the analyzer 114(1) may use the information in the attribute values store 126. For example, if the learner L1 answered the test question in assessment learning object O1 correctly, the analyzer 114(1) may search the attribute values store 126 for an assessment learning object that is associated with topic T1 and that has a higher “difficulty level” value than that of assessment learning object O1. Conversely, if the learner L1 answered the test question in assessment learning object O1 incorrectly, the analyzer 114(1) may search the attribute values store 126 for an assessment learning object that is associated with topic T1 and that has a lower “difficulty level” value than that of assessment learning object O1. In making the recommendation, the analyzer 114(1) may also take the skill level of learner L1 into account. For example, if learner L1 is highly skilled in topic T1, the analyzer 114(1) may recommend an assessment learning object having a higher “difficulty level” value than if learner L1 were not highly skilled in topic T1. By recommending the next test question in this way, the analyzer 114(1) helps to gauge the knowledge level of the learner L1 with regard to topic T1, and helps to keep the learner challenged. This and other functions may be performed by the analyzer 114(1).

### Use Case #2

In this use case, an updated value is derived for an attribute of a particular learning object based upon learner actions taken by a plurality of learners on one or more other learning objects that are related to the particular learning object.

Suppose that a learner, with learner identifier L2, uses the learner device 102 to interact with application 108(n) to participate in a course having course identifier C2. At some point in the interaction, application 108(n) renders an assessment learning object having object identifier O2 to the learner to test the learner's knowledge of a topic T2 taught by the course C2. In this use case, the assessment learning object is a test type of learning object that contains a plurality of test questions. For this use case, it will be assumed that all of the test questions in the assessment learning object O2 pertain to topic T2, and that the assessment learning object O2 has two static attributes, “course” and “topic”, which have values C2 and T2, respectively.

When the learner submits a response to the assessment learning object (the test), the application 108(n) interprets the response as a learner action taken by the learner on the assessment learning object. The application 108(n) performs several operations in response. These operations include determining the various aspects of the learner action. In this use case, the application 108(n) notes the answer (if any) provided by the learner to each test question, determines whether each answer is correct or incorrect, and determines how well the learner did overall on the test (e.g. what percentage of the test questions the learner answered correctly). The application 108(n) saves these aspects of the learner action, along with some identifying information (e.g. a session identifier, the object identifier O2, the learner identifier L2, etc.), in the repository 120 for potential later use. The application 108(n) also sends a learner action message to the listener 110 to notify the listener 110 of the learner action. This message may include the following information: (a) the learner action type (in this use case, the action type would be a response to a test with multiple test questions); (b) the assessment learning object identifier O2; (c) the session identifier; and (d) context information that includes the learner identifier L2 and the course identifier C2.

Upon receiving the learner action message, the listener 110 forwards the message to the service manager 112. In turn, using the information in the learner action message, and the analyzer mapping discussed previously, the service manager 112 selects one or more of the analyzers 114 to which to forward the learner action message for further processing. In this use case, it will be assumed that the learner action message is forwarded to analyzer 114(n). It will also be assumed that analyzer 114(n) performs processing to derive an updated value for a dynamic attribute of a learning object that is related to the assessment learning object O2.

To do so, the analyzer 114(n) determines (for example, by consulting the learning object attribute values store 126) that the assessment learning object O2 has a “course” attribute value of C2 and a “topic” attribute value of T2. The analyzer 114(n) then searches the relationship store 122 for content learning objects that have the same values for these attributes. Presumably, these would the content learning objects that include, reference, or contain the content materials that are used to teach topic T2 in course C2. Hence, these content learning objects are related to the assessment learning object O2 in that they teach the topic T2 in course C2 while the assessment learning object O2 tests the topic T2 in course C2. For the sake of simplicity, it will be assumed that the analyzer 114(n) finds just one content learning object that meets these criteria. It will also be assumed that this content learning object has an object identifier O3, and a dynamic attribute named “teaching effectiveness”, which indicates how effective the content learning object O3 is in teaching topic T2. In this use case, the analyzer 114(n) performs processing to derive an updated value for the “teaching effectiveness” attribute of the content learning object O3.

To do so, the analyzer 114(n) needs more information. Thus, using information from the learner action message (e.g. the object identifier O2 and the session identifier), the analyzer 114(n) queries the application 108(n) for information pertaining to the aspects of the learner action referenced in the message. As a result of this query, the analyzer 114(n) receives from the application 108(n) the aspects of the learner action, which may include the answer (if any) provided by the learner L2 to each test question, an indication of whether the learner answered each question correctly, and an indication of how well the learner did overall on the test (e.g. what percentage of the test questions the learner answered correctly). The analyzer 114(n) may also query the application 108(n) for information pertaining to aspects of learner actions taken previously by other learners on the assessment learning object O2. This information may indicate, for example, how many other learners have submitted responses to the test and how well each learner performed on the test. Furthermore, it may be possible for multiple tests to be used in course C2 to test a learner's knowledge of topic T2. Thus, the analyzer 114(n) may further query the application 108(n) for information pertaining to aspects of learner actions taken previously by other learners on other test-type assessment learning objects that have a “course” attribute value of C2 and a “topic” attribute of T2. This information may indicate, for example, how many learners have submitted responses to the other test-type assessment learning objects and how well each learner performed on those tests. With all of above information, the analyzer 114(n) can derive an updated value for the “teaching effectiveness” attribute of the content learning object O3.

For example, if the information received from the application 108(n) indicates that most of the learners have performed poorly on the tests for topic T2, then it may indicate that the content in the content learning object O3 is not effectively teaching the topic T2; hence, a lower value may be assigned to the “teaching effectiveness” attribute of the content learning object O3. Conversely, if the information received from the application 108(n) indicates that most of the learners have performed well on the tests for topic T2, then it may indicate that the content in the content learning object O3 is teaching the topic T2 effectively; hence, a higher value may be assigned to the “teaching effectiveness” attribute of the content learning object O3.

Notice from the above discussion that the “teaching effectiveness” attribute of the content learning object O3 is derived based upon learner actions taken on assessment learning object O2 and perhaps other assessment learning objects. Thus, in this use case, an updated value is derived for an attribute of a learning object based upon learner actions taken by a plurality of learners on one or more other learning objects that are related to the learning object.

After deriving the updated value for the “teaching effectiveness” attribute, the analyzer 114(n) may forward the updated value to the service manager 112, which in turn stores the updated value into the attribute values store 126. Alternatively, the analyzer 114(n) may store the updated value into the attribute values store 126 itself. Once updated and stored, the attribute value may be used to make intelligent and effective decisions on whether and when to use the content learning object O3 to educate a learner. For example, suppose a client (e.g. a professor), using client device 106, submits a recommendation request to the service manager 112 for recommendations on content to use to teach topic T2. Based upon the updated attribute value for the “teaching effectiveness” attribute, the service manager 112 can intelligently and effectively decide whether to recommend content learning object O3 to the client.

For maximum effectiveness, it may be desirable to keep the dynamic attribute values of learning objects as current as possible. To do so, the dynamic attributes may be updated each time a relevant learner action is detected. In the current use case, the analyzer 114(n) updates the value of the “teaching effectiveness” attribute of content learning object O3 each time a learner action is performed on the assessment learning object O2. As an alternative, the analyzer 114(n) may update the value of the “teaching effectiveness” attribute at certain intervals (e.g. every twentieth learner action performed on the assessment learning object, at certain time intervals, etc.). As a further alternative, the analyzer 114(n) may update the value of this attribute as needed (e.g. when the analyzer 114(n) or another component needs to use the value of the attribute to, for example, make a decision, make a recommendation, etc.). For purposes of the present invention, these and other approaches may be used for updating the attribute value.

In addition to deriving an updated value for the dynamic attribute of content learning object O3, the analyzer 114(n) may also perform additional functions. For example, if the learner L2 did not perform well on the test, the analyzer 114(n) may recommend another content learning object that teaches the topic T2 that the learner may study to learn the topic T2 better. To make this recommendation, the analyzer 114(n) may search the learning object attribute values store 126 for content learning objects that have a “topic” attribute value of T2 and a “teaching effectiveness” value greater than a certain threshold. Once the recommended content learning objects are identified, the analyzer 114(n) may recommend them to the application 108(n), and the application 108(n) may provide them to the learner to help the leaner learn the topic T2 better. This and many other functions may be performed by the analyzer 114(n).

### Hardware Overview

With reference to FIG. 3, there is shown a block diagram of a computer system that may be used to implement at least a portion of the present invention. Computer system 300 includes a bus 302 or other communication mechanism for communicating information, and one or more hardware processors 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques disclosed herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage device 310, or other non-volatile storage for later execution.

At this point, it should be noted that although the invention has been described with reference to specific embodiments, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims.

What is claimed is:

1. A method, comprising:
receiving information pertaining to one or more aspects of a learner action taken by a first learner on a first learning object, wherein the first learning object is an assessment learning object that is used to assess the first learner's knowledge of one or more topics;
based, at least in part, upon the information pertaining to the one or more aspects of the learner action taken by the first learner and upon information pertaining to one or more aspects of learner actions taken previously by other learners, deriving an updated value for an attribute associated with a second learning object, wherein the second learning object may be the first learning object or another learning object that is related to the first learning object; and
storing the updated value for the attribute;
wherein the method is performed by one or more computing devices.

2. The method of claim 1, wherein the second learning object is the first learning object, wherein the first learning object comprises a test question, wherein the learner action taken by the first learner on the first learning object comprises submitting a response to the test question, and wherein the information pertaining to the one or more aspects of the learner action taken by the first learner includes at least one of: whether the response contains a correct answer for the test question; how much time the first learner took to respond to the test question; and whether the response contains an answer to the test question at all.

3. The method of claim 2, wherein the attribute is one of: a difficulty level for the test question; a discrimination level for the test question; and a guess level for the test question.

4. The method of claim 2, further comprising:
determining, based at least in part upon the updated value for the attribute, whether to present the test question to a second learner.

5. The method of claim 1, wherein the second learning object is a content learning object that is related to the first learning object, wherein the second learning object includes, references, or contains content that teaches the one or more topics, wherein the first learning object comprises a test having one or more test questions on the one or more topics, wherein the learner action taken by the first learner on the first learning object comprises submitting a response to the test, and wherein the information pertaining to the one or more aspects of the learner action taken by the first learner includes at least an indication of how well the first learner performed on the test.

6. The method of claim 5, wherein the attribute associated with the second learning object for which the updated value is derived is a teaching effectiveness attribute that indicates how effective the content included, referenced, or contained in the second learning object is at teaching the one or more topics.

7. The method of claim 6, further comprising:
determining, based at least in part upon the updated value for the teaching effectiveness attribute of the second learning object, whether to use the second learning object to teach the one or more topics.

8. The method of claim 1, wherein the first learner has an associated learner profile, and wherein the updated value for the attribute is derived based, at least in part, upon the information pertaining to the one or more aspects of the learner action taken by the first learner, upon information pertaining to one or more aspects of learner actions taken previously by other learners, and upon information in the learner profile.

9. The method of claim 8, wherein the learner profile comprises information indicating a knowledge level of the first learner, and wherein the updated value for the attributed is derived based at least in part upon the knowledge level of the first learner.

10. The method of claim 1, wherein the operation of deriving the updated value for the attribute associated with the second learning object is performed by a first component, and wherein the method further comprises:
selecting the first component from a plurality of components, based at least in part upon the first learning object and the learner action taken by the first learner.

11. The method of claim 10, further comprising:
receiving information pertaining to one or more aspects of a second learner action taken by a second learner on a third learning object, wherein the third learning object is an assessment learning object that is used to assess the second learner's knowledge of one or more topics;
selecting a second component from the plurality of components, based at least in part upon the third learning object and the second learner action taken by the second learner;
based, at least in part, upon the information pertaining to the one or more aspects of the second learner action taken by the second learner and upon information pertaining to one or more aspects of learner actions taken previously by other learners, deriving an updated value for an attribute associated with a fourth learning object, wherein the fourth learning object may be the third learning object or another learning object that is related to the third learning object, and wherein the operation of deriving the updated value for the attribute associated with the fourth learning object is performed by the second component; and
storing the updated value for the attribute associated with the fourth learning object;
wherein the first and second components implement different methodologies for deriving the updated value for the attribute associated with the second learning object and deriving the updated value for the attribute associated with the fourth learning object.

12. A system comprising one or more computers, wherein the one or more computers are configured to perform the operations of:
receiving information pertaining to one or more aspects of a learner action taken by a first learner on a first learning object, wherein the first learning object is an assessment learning object that is used to assess the first learner's knowledge of one or more topics;
based, at least in part, upon the information pertaining to the one or more aspects of the learner action taken by the first learner and upon information pertaining to one or more aspects of learner actions taken previously by other learners, deriving an updated value for an attribute associated with a second learning object, wherein the second learning object may be the first learning object or another learning object that is related to the first learning object; and
storing the updated value for the attribute.

13. The system of claim 12, wherein the second learning object is the first learning object, wherein the first learning object comprises a test question, wherein the learner action taken by the first learner on the first learning object comprises submitting a response to the test question, and wherein the information pertaining to the one or more aspects of the learner action taken by the first learner includes at least one of: whether the response contains a correct answer for the test question; how much time the first learner took to respond to the test question; and whether the response contains an answer to the test question at all.

14. The system of claim 13, wherein the attribute is one of: a difficulty level for the test question; a discrimination level for the test question; and a guess level for the test question.

15. The system of claim 13, wherein the one or more computers are configured to further perform the operation of:
determining, based at least in part upon the updated value for the attribute, whether to present the test question to a second learner.

16. The system of claim 12, wherein the second learning object is a content learning object that is related to the first learning object, wherein the second learning object includes, references, or contains content that teaches the one or more topics, wherein the first learning object comprises a test having one or more test questions on the one or more topics, wherein the learner action taken by the first learner on the first learning object comprises submitting a response to the test, and wherein the information pertaining to the one or more aspects of the learner action taken by the first learner includes at least an indication of how well the first learner performed on the test.

17. The system of claim 16, wherein the attribute associated with the second learning object for which the updated value is derived is a teaching effectiveness attribute that indicates how effective the content included, referenced, or contained in the second learning object is at teaching the one or more topics.

18. The system of claim 17, wherein the one or more computers are configured to further perform the operation of:
determining, based at least in part upon the updated value for the teaching effectiveness attribute of the second learning object, whether to use the second learning object to teach the one or more topics.

19. The system of claim 12, wherein the first learner has an associated learner profile, and wherein the updated value for the attribute is derived based, at least in part, upon the information pertaining to the one or more aspects of the learner action taken by the first learner, upon information pertaining to one or more aspects of learner actions taken previously by other learners, and upon information in the learner profile.

20. The system of claim 19, wherein the learner profile comprises information indicating a knowledge level of the first learner, and wherein the updated value for the attributed is derived based at least in part upon the knowledge level of the first learner.

21. The system of claim 12, wherein the operation of deriving the updated value for the attribute associated with the second learning object is performed by a first component, and wherein the one or more computers are configured to further perform the operation of:
selecting the first component from a plurality of components, based at least in part upon the first learning object and the learner action taken by the first learner.

22. The system of claim 21, wherein the one or more computers are configured to further perform the operations of:
receiving information pertaining to one or more aspects of a second learner action taken by a second learner on a third learning object, wherein the third learning object is an assessment learning object that is used to assess the second learner's knowledge of one or more topics;
selecting a second component from the plurality of components, based at least in part upon the third learning object and the second learner action taken by the second learner;
based, at least in part, upon the information pertaining to the one or more aspects of the second learner action taken by the second learner and upon information pertaining to one or more aspects of learner actions taken previously by other learners, deriving an updated value for an attribute associated with a fourth learning object, wherein the fourth learning object may be the third learning object or another learning object that is related to the third learning object, and wherein the operation of deriving the updated value for the attribute associated with the fourth learning object is performed by the second component; and
storing the updated value for the attribute associated with the fourth learning object;
wherein the first and second components implement different methodologies for deriving the updated value for the attribute associated with the second learning object and deriving the updated value for the attribute associated with the fourth learning object.
